(19) United States
(12) Patent Application Publication
(10) Pub. No.: US 2006/0011424 A1
(43) Pub. Date: Jan. 19, 2006

(54) Wheel valve stem shield for air disc brake applications

(76) Inventors: David J. Goodell, Beaverton, OR (US); Ronald S. Plantan, Westlake, OH (US); Aurel Crisan, Marysville, WA (US)

Correspondence Address: CROWELL & MORING LLP;INTELLECTUAL PROPERTY GROUP, P.O. BOX 14300, WASHINGTON, DC, 20044-4300, US

(21) Appl. No.: 10/890,373

(22) Filed: Jul. 14, 2004

(51) Int. Cl. B60B 7/00

(52) U.S. Cl. 188/218 A; 301/37.105

(57) ABSTRACT

When a disc brake is mounted on an axle, particularly an air disc brake on the axle of a commercial vehicle, there is a possibility that an incompatible wheel may be installed. When such a wheel then rotates, interference between wheel and disc brake components may occur, such as a wheel valve stem striking the brake caliper. Equipment damage and tire deflation may result. In order to preclude such brake-wheel interference, a disc brake shield device is interposed between the disc brake and the wheel. When an incompatible wheel is installed over the shield device, the valve stem is deflected away from the brake components. The shield device may further be provided with vanes to circulate cooling air, and may include recesses to minimize valve stem deflection and cut-away portions to enhance brake inspection and maintenance, as long as contact with brake components continues to be precluded.

### BACKGROUND AND SUMMARY OF THE INVENTION

The present invention relates to disc brakes for vehicles and, in particular, to devices for preventing interference between vehicle wheels and air-operated disc brakes on commercial vehicles.

Pneumatically-operated disc brakes have been undergoing development and deployment on commercial vehicles since at least the 1970's, and are beginning to replace drum-style brakes due to advantages in areas such as cooling, fade resistance and serviceability. German patent publication DE 40 32 886 A1, and in particular FIG. 1 of this document, discloses an example of such an air disc brake. In this design, a pneumatic diaphragm chamber 12 is attached to a rear face of the disc brake caliper housing 3, and applies a brake actuation force through a linear actuator rod 10 to a brake actuator lever 9 within the caliper. The brake's actuator lever in turn transfers and multiplies the force applied by the actuator rod to one or more spindles 14, which force brake pads 20 against a brake disc or rotor 1. The terms “brake disc,” “rotor” and “brake rotor” are used interchangeably herein.

The adaptation of disc brake technology to commercial vehicle applications has not been without engineering challenges. With a conventional axle, particularly a conventional commercial vehicle axle, a hub member rotatably mounted on the end of the axle is configured with a flange located on an outboard end of the hub for receiving a bolting flange of a wheel rim. Where such axles are equipped with a conventional disc brake, a brake rotor is typically mounted to the hub inboard of the hub's wheel bolting flange, and the brake caliper straddles the rotor and is non-rotatably mounted to the axle. Commercial vehicle wheel rims used on such axles are sized, both in diameter and axial offset, to provide adequate clearance for the drum-type brakes historically employed on such vehicles. The resulting space envelope between the wheel and its axle is limited, leaving little space available for a pneumatic disc brake. Further, the deep offset of a typical commercial vehicle wheel essentially surrounds the axle hub and the brake mounted thereon, substantially inhibiting free flow of cooling air to the brake.

A concern with tight clearance between air disc brake components and vehicle wheels arises from the availability of a considerable variety of commercial vehicle wheel sizes and rim configurations. Variations in wheel profile and the location of wheel components, such as wheel valve stems, may result in undesirably small clearances, or even direct interference, between the air disc brake components and the rotating wheel if an incompatible wheel is mounted to a vehicle axle. This is a particular concern when a wheel has its valve stem located on the inboard side of the wheel, i.e., on the side of the wheel facing toward the center of an axle (so-called “inboard” or “internal” valve stems).

Mounting of an inboard valve stem-equipped wheel over a typical commercial vehicle drum brake normally presents no problems with respect to damaging wheel valve stems, because the brake drum and wheel rotate together (thereby precluding impact damage to the valve stem as the wheel rotates), and because there normally is sufficient flexibility in the valve stem to allow the brake drum to push the valve stem slightly outward (while maintaining the valve stem intact) if the wheel is incompatible with the brake.

In contrast, with an air disc brake, the wheel and its valve stem rotate about a stationary, axle-mounted disc brake caliper. If there is interference between the valve stem and the caliper, valve stem damage may result.

Air disc brakes also present a greater challenge with regard to detecting installation of incompatible wheels. With drum brake, there is the possibility that a technician installing an incompatible wheel may notice resistance from the wheel valve stem's encountering the brake drum as the wheel is moved into its mounted position. This resistance provides a signal to the technician that he should investigate and resolve the interference between the brake drum and the valve stem. With an air disc brake, the technician's discovery of wheel-brake interference is less likely to occur. Because the brake caliper occupies only a small fraction of the circumferential space between the axle and the wheel rim, it is possible for an incompatible wheel to be placed into its mounted position without encountering an interfering brake component (and thereby signal to the technician of the wheel's incompatibility with the brake). In such a case, the interference may go undetected until the wheel is rotated and the valve stem is damaged.

In view of the potential for wheel/brake interference and resulting equipment damage, measures may need to be taken to discourage the mounting of an incompatible wheel on an air disc brake-equipped axle. This option presents logistic and maintenance difficulties in attempting to prevent inadvertent installation of an incompatible wheel at a field maintenance facility. Alternatively, the air disc brake size may be limited to ensure there will always be sufficient excess clearance so that no wheel-brake interference can result, regardless of the configuration of the wheel mounted to the axle. However, this solution may undesirably limit the potential performance of the air disc brake by limiting the size of its friction-generating and heat-dissipating components.

In order to overcome the foregoing problems, it is an object of the present invention to provide device which shields a wheel and its components from interference with the components of an air disc brake, thereby minimizing the potential for wheel and valve stem damage and providing for greater flexibility in accommodating various wheel configurations. The shield is preferably designed to be the first point of interference between an incompatible wheel, thereby providing a technician an indication of the installation of an incompatible wheel, and if the incompatible wheel is still installed, reducing the possibility of valve stem damage by providing for controlled deflection of the valve stem in a manner which should minimize valve stem leakage. In some cases the shield might cause valve stem leakage as the wheel is being installed, in which case the service technician should be provided an audible warning of the leakage and have the opportunity to take corrective action.

It is a further objective of the present invention to provide a shield which does not require compromise of disc brake size, and hence brake performance. It is also an objective to provide a shield which maintains air flow in the vicinity of the shield in order to cool axle bearings and seals. A further objective is to provide an easily installed shield which may be installed without separate mounting fixtures if desired. Another objective is to provide a shield which results in minimal adverse impact on disc brake inspection and maintenance.

The foregoing objectives are obtained by a generally conical- or “bell-shaped” shield device extending circumferentially around the entire annular space between a wheel installed on the axle hub and the air disc brake, such that contact between the wheel and its valve stem and any air disc brake components, including the brake caliper, is precluded. The shield may be installed, for example, on the hub of a vehicle axle, or directly adjacent to the axle hub on the rotor of an air disc brake. In a first embodiment, the shield is formed with a flange face with holes corresponding to the pattern of lug studs on the axle hub, such that the shield may be simply placed over the lug studs, and then captured between the axle hub and the bolt flange of the wheel when the wheel is installed.

Because the shield and the wheel rotate together, if there is any interference between the shield and the wheel or its components (such as contact between the shield and the wheel valve stem which forces the valve stem to flex out of its “free standing” position), there is no relative motion between the wheel and the shield to cause damage to the valve stem.

In order to preclude shield-to-brake caliper interference as the shield rotates with the wheel about the axle hub, the shield must be formed with sufficient rigidity to preclude its deformation inward under a load (such as the pressure applied by an impinging wheel valve stem) to an extent that exposed the valve stem to damage. In some cases, it may be acceptable for the shield to slightly deform under force from the stem, such that shield and stem would be deflected further way by the caliper on first wheel rotation, as long as the shield's deformation by the caliper does not damage the valve stem.

In another embodiment of the present invention, rather than capturing the shield between the axle hub flange and the wheel bolt flange, the shield may be mounted on another component which rotates with the wheel (including the wheel itself). For example, because the brake rotor of the air disc brake rotates with the wheel, the rotor's hub flange could be provided with radially-outward facing projections at intervals about the periphery of its mounting flange. The projections could be arranged to support a mating surface at an inner radius of the shield and receive shield-retaining fasteners, such as screws.

In a further embodiment, the shield may be provided with relieved portions at circumferential locations about its outboard (i.e., wheel-side) surface. The relieved or “scalloped” sections would roughly correspond to locations at which wheel valve stems are likely to reside when a wheel is installed on an axle. These relieved areas would allow the shield to be larger in diameter, providing more clearance for cooling and making installation of incompatible wheels more difficult or even impossible. Accordingly, a technician installing a wheel would be required to locate the valve stem in the recessed area or well. Otherwise, the attempt to install the wheel would call attention to the potential wheel incompatibility and the need for the technician to confirm satisfactory clearance. Warning indicators such as labels or embossed or blanked text may be included on the shield adjacent to the recessed area or well in order to call the technician's attention to the need to confirm stem clearance and take corrective action in the event of unacceptable interference.

Another embodiment may include cooling air passages at an inner radius region of the shield, as well as cooling vanes adjacent to these passages. With this configuration, when the wheel and shield are rotating, the air near the axle hub is drawn axially outward along the axle hub to provide cooling to the hub bearings and seals. The air then may pass radially outward along the shield to provide cooling air to all the components within or near the circumferential gap, including the wheel, the shield, and the air disc brake components. A further benefit of such forced air cooling is that the radially-outward-flowing cooling air may carry brake dust from the brake pads away from the wheel as the air departs the wheel region.

In a further embodiment, apertures or “windows” may be provided in regions of the shield unlikely to encounter wheel elements, such as a valve stem. These apertures may be provided to allow access to brake or hub components for inspection and limited servicing without removal of the shield.

The present invention's shield device provides a number of advantages, including: preventing wheel and valve stem damage resulting from use of an incompatible wheel with an air disc brake-equipped axle; providing an early warning signal to a technician that an incompatible wheel is being installed on a disk brake-equipped axle (i.e., resistance felt as the valve stem is deflected); allowing a greater range of wheel designs to be used with air disc brakes than might otherwise be possible (due to elimination of valve stem impact concerns); providing additional cooling of axle hub bearings and seals to enhance bearing and seal life; providing a low-cost valve stem protection solution which is simple to manufacture, install and maintain; protecting wheel components from heat generated by an air disc brake; and allowing use of larger diameter, and hence more powerful and fade resistant, air disc brakes (due to the reduction in clearance required to avoid potential interference between brake caliper and a wheel rim components.

Other objects, advantages and novel features of the present invention will become apparent from the following detailed description of the invention when considered in conjunction with the accompanying drawings.

### BRIEF DESCRIPTION OF THE DRAWINGS

FIGS. 1A and 1B are oblique and side views, respectively, of an axle hub equipped with an air disc brake and a shield device in accordance with an embodiment of the present invention.

FIG. 2 is an oblique view of the shield device shown in FIGS. 1A and 1B.

FIG. 3 is a partial cross section view of the axle hub, air disc brake and shield device arrangements of FIGS. 1-2, showing the deflection of a wheel valve stem when an incompatible wheel is installed on the axle hub.

FIG. 4 is an oblique view of a brake rotor adapted to support another embodiment of the shield device in accordance with the present invention.

FIG. 5 is a shield device configured to be used with the brake rotor illustrated in FIG. 4 in accordance with an embodiment of the present invention.

FIG. 6 is a detailed partial cross-section view of a shield device mounting arrangement in accordance with a further embodiment of the present invention.

FIG. 7 is a partial oblique view of a shield device in accordance with a further embodiment of the present invention.

FIG. 8 is a partial cross-section view of a shield device arrangement with enhanced cooling air flow in accordance with a further embodiment of the present invention.

### DETAILED DESCRIPTION OF THE DRAWINGS

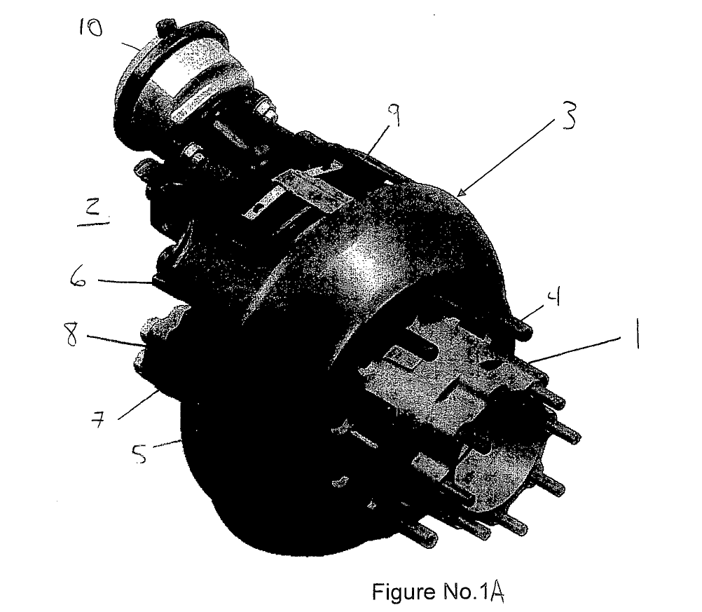

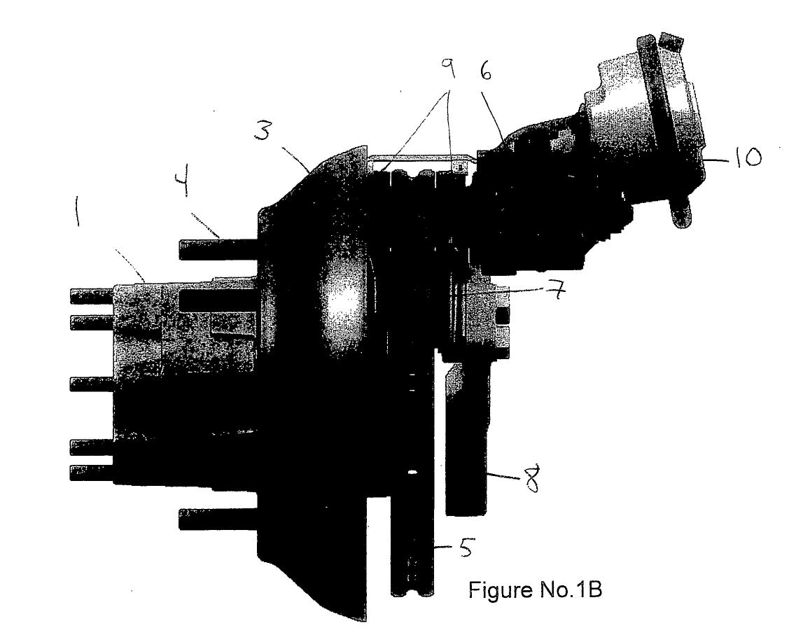

FIGS. 1A and 1B are FIGS. 1A and 1B are oblique and side views, respectively, of an axle hub 1 of a vehicle axle which is equipped with an air disc brake 2 and a shield device 3 in accordance with a first embodiment of the present invention.

Axle hub 1 includes a circular arrangement of wheel-retaining lug studs 4 for receiving and retaining a wheel (not illustrated). The axle hub is rotatably supported by the vehicle axle with internal bearings (not illustrated) in a conventional manner.

The air disc brake 2 comprises a brake rotor 5 located on, and engaged with, the axle hub 1, such that the brake rotor rotates with the axle hub 1. The brake rotor 5 may be a one-piece component, or, as in this embodiment, a hub-rotor assembly (hereinafter, the “brake rotor”). An air disc brake caliper 6 is non-rotatably mounted to the vehicle axle via a caliper supporting mount 7, which is bolted to a mounting plate 8 affixed to the vehicle axle. The caliper 6 is actuated by pneumatic diaphragm actuator 10 to press brake pads into frictional engagement with rotor 5.

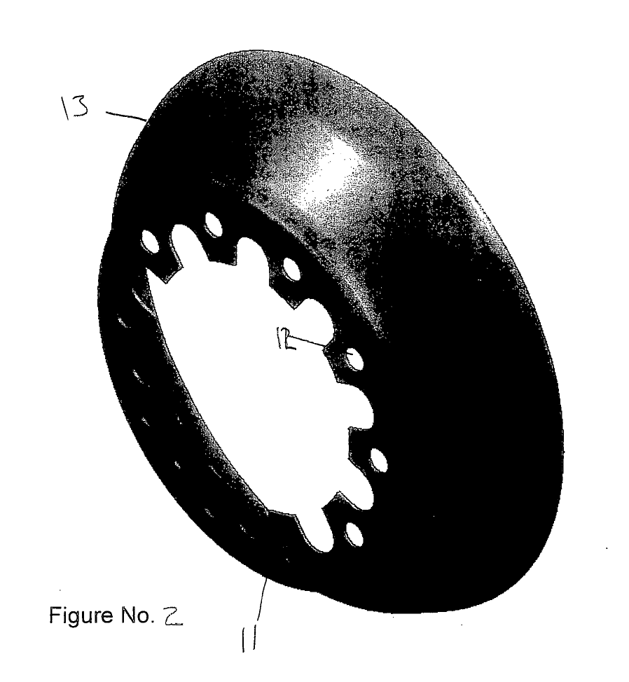

In this embodiment, the shield device 3 is shown in FIGS. 1A and 1B in its installed position, prior to installation of a wheel. As shown in FIG. 2, the shield device 3 is formed with a generally conical or bell shape. A substantially flat axle hub flange face 11 is configured with a pattern of holes 12 corresponding to the pattern of lug studs 4 on axle hub 1. A bell-shaped portion 13 of shield device 3 is formed in a manner which conforms to the general outline of air disc brake 2. The shield device 3 may be formed by any of a variety of well-known manufacturing techniques, such as metal stamping, composite material molding, casting or formed from steel rod with welded spokes. The shield device 3 is installed on axle hub 1 by sliding the shield over lug studs 4 until the shield device's hub flange face 11 abuts the face of axle 1's bolting flange (flange 17 is described further, below).

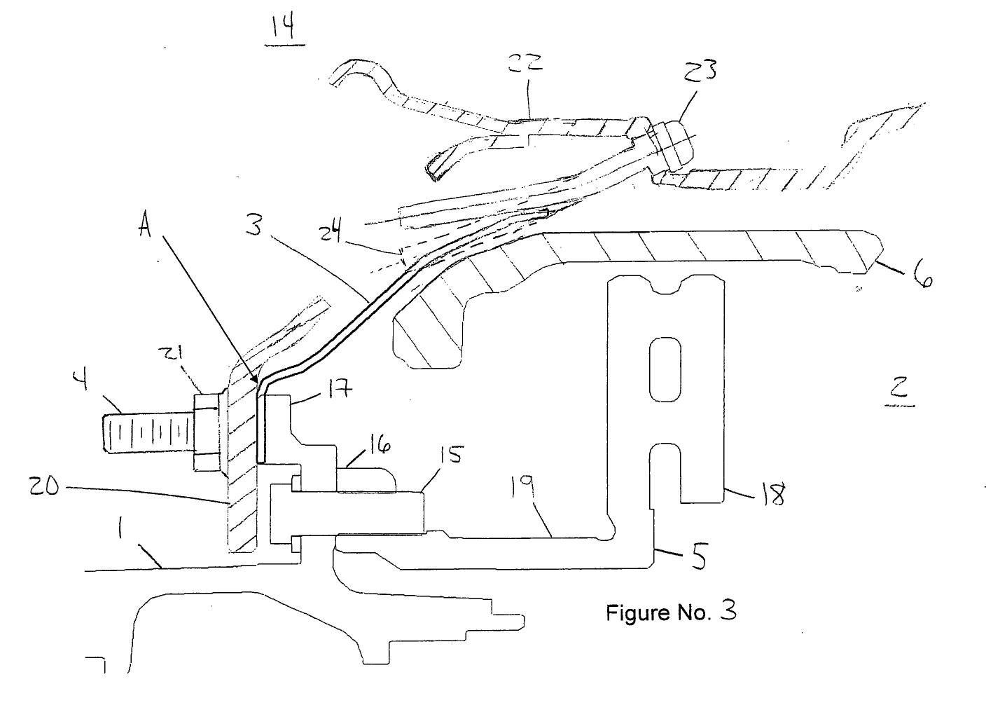

FIG. 3 illustrates the arrangement of the components in FIGS. 1A and 1B when a wheel 14 is installed on axle hub 1. FIG. 3 is a partial cross-section view of the FIG. 1 arrangements, wherein axle hub 1 supports brake rotor 5 via fasteners 15, which hold rotor hub face 16 against the inboard side of axle hub bolting flange 17. The brake rotor friction surface 18 is joined to the rotor hub face 16 by a cylindrical neck 19. For clarity, brake caliper 6 is shown in its mounted location, without illustration of its supporting mount or the brake pads.

In this embodiment, the flange face 11 of shield device 3 is captured and held against the axle hub bolting flange 17 at point A by the bolting flange 20 of wheel 14. The wheel is retained on axle hub lug studs 4 by lug nuts 21. As shown in FIG. 3, the conical portion 13 of shield device 3 extends into the circumferential gap between caliper 6 and the rim portion 22 of wheel 14. The conical portion of the shield extends inboard, at a minimum, as far as is necessary to ensure that the shield device is interposed between caliper 6 and wheel valve stem 23. One of ordinary skill in the art will recognize wheel bolting flange 20 and wheel rim portion 22 are joined to one another out of the plane of the cross-section view of FIG. 3, and that the gap between these components in FIG. 3 corresponds to a valve stem access aperture (also known as “hand holds”) in the face of the wheel.

FIG. 3 illustrates a wheel installation case in which an incompatible wheel, i.e., a wheel equipped with an internal valve stem which would interfere with the brake caliper when the wheel rotates, has been placed over the axle hub 1 and moved toward the air disc brake 2. With the shield device present, the wheel valve stem 23 is deflected radially outward as the wheel is pressed against the axle hub bolting flange (illustrated in FIG. 3 by the solid line representation of valve stem 23). If the shield device 3 were not present, the wheel valve stem 23 may, in its undeflected state (illustrated by dashed lines 24), strike the brake caliper 6 as the wheel is rotated.

With the shield device 3 in place, a technician installing wheel 14 may be able to feel the resistance of the valve stem 23 deflecting against shield device 3 as the wheel 14 is placed into position. The technician is thus provided the opportunity to recognize the incompatibility of the wheel and take appropriate corrective action. If, however, the technician does not remove the wheel 14, because wheel 14 and shield device rotate together on axle hub 1, there will be no relative motion between wheel valve stem 23 and shield device 3. As a result, if the deflection of valve stem 23 by shield device 3 is relatively minor, i.e., small enough that wheel valve stem 23 remains intact once the wheel is installed, the wheel may still be used without risk of valve stem damage caused by either the shield device or any of the brake components behind the shield.

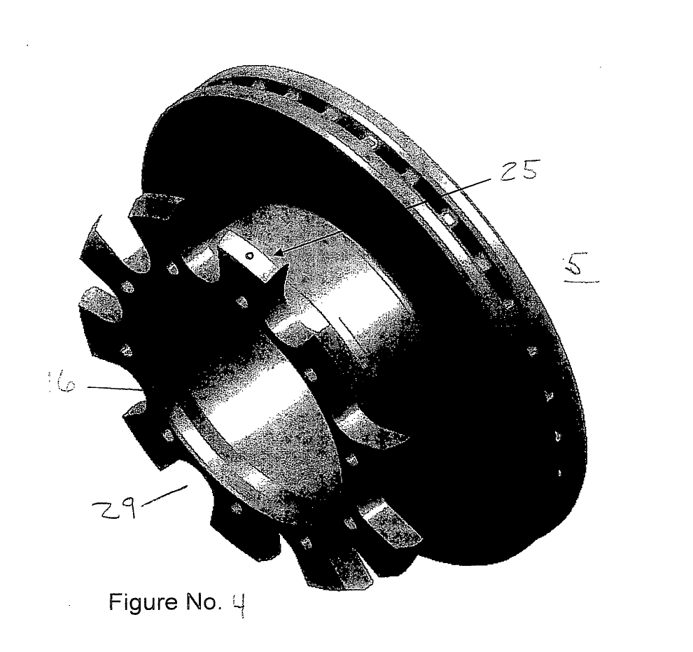

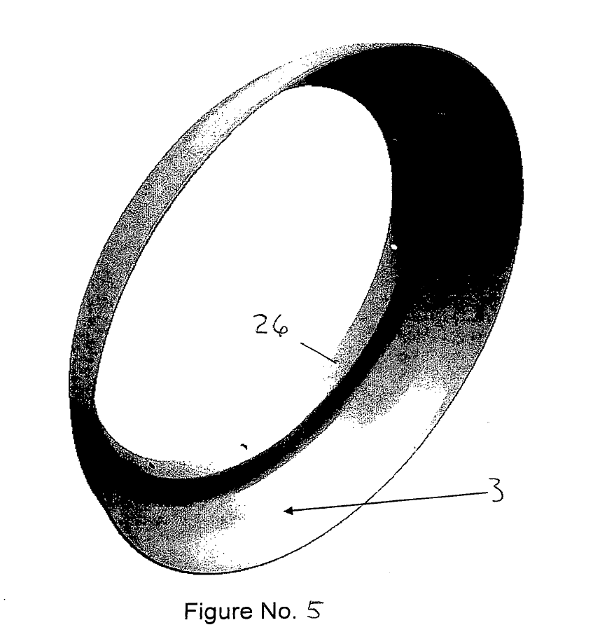

The location of the shield de ice 3 is not limited to mounting on the axle hub 1, as long as the shield device rotates with the wheel 14. For example, as shown in FIG. 4, brake rotor 5 may be provided at or near its hub face 16 with shield support projections 25, to which shield device 3 may be directly attached, for example, with screws passing through holes 26 in shield device 3, illustrated in FIG. 5. This embodiment permits the wheel 14 to be removed from the axle hub while the shield device remains firmly mounted on the axle. In this manner, assurance is provided that the shield device 3 is not removed and then inadvertently omitted when a wheel is reinstalled, which could potentially lead to damage of an incompatible wheel's valve stem.

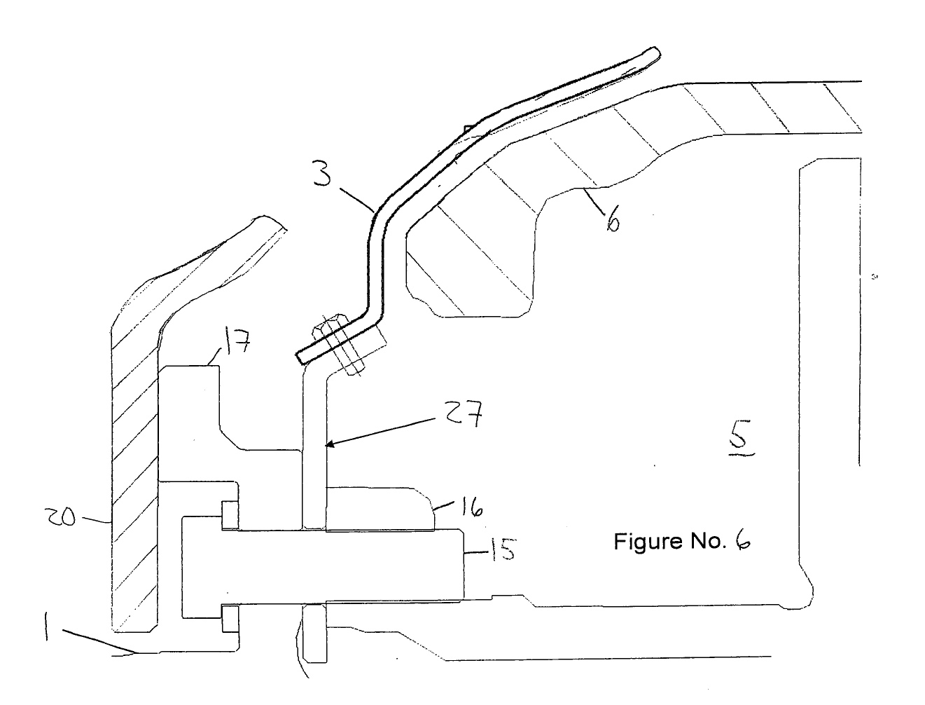

Another alternative shield device mounting approach is illustrated in FIG. 6. In this embodiment, a shield mounting plate 27 is captured between axle hub bolting flange 17 and the hub flange 16 of brake rotor 5. As in the previous embodiment, shield device 3 is affixed to shield mounting plate 27 with screws in a location which ensures the shield device is interposed between brake caliper 6 and the valve stem of the wheel.

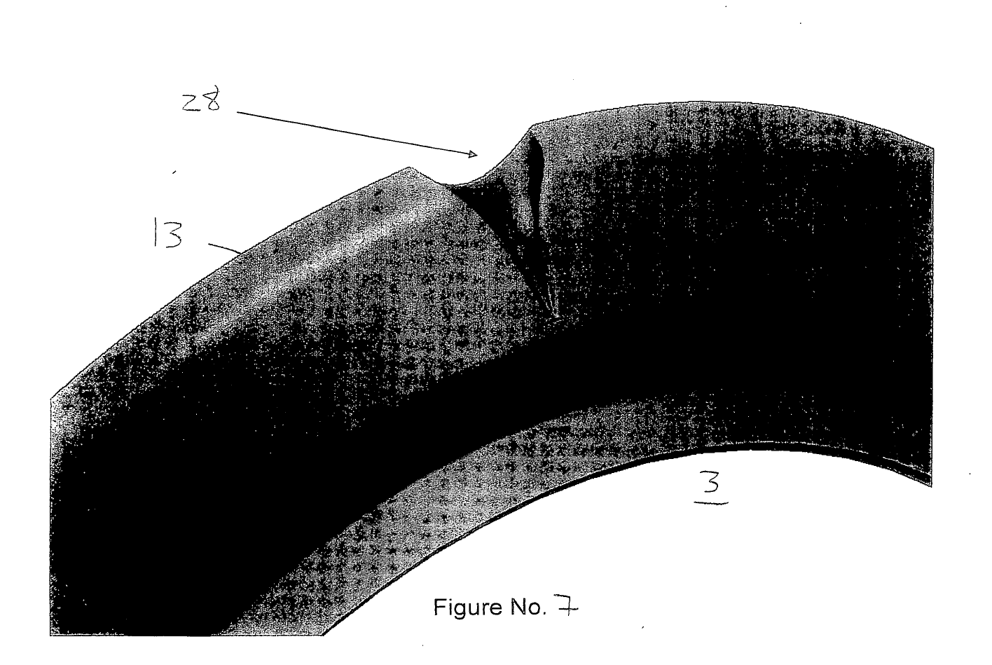

In a further development of the present invention, the shield device may be provided with notches, “scalloped” recesses or cut-out portions about is outer periphery in order to enhance compatibility with the various wheels available in commerce, as long as prevention of interference between brake components and wheel components is maintained. For example, as shown in FIG. 7, shield device 3 may be provided with one or more valve stem wells 28 in the radially outer region of conical portion 13 in order to minimize the bending stresses applied to a valve stem which comes into contact with shield device 3. In addition, the relieved valve stem well 28 allows the shield conical portion 13 to be made with a larger diameter. This additional space may be used to increase clearance between the shield and the brake components, permit a larger diameter brake rotor and caliper to be installed to increase brake performance, and/or to allow greater cooling air flow within the shield/brake region. In addition, the larger diameter increases difficulty for incompatible wheel installation, i.e., making it even more apparent to the technician installing an incompatible wheel or a wheel whose valve stem is not aligned with the valve stem well 28 that there is a problem.

The depth of valve stem well 28 is limited only by the amount of clearance available between the inboard surface of shield device 3 and the adjacent brake components. This embodiment is particularly well suited for use with wheels which have their valve stems located at a known circumferential position relative to the wheel's lug holes, as the valve stem well 28 may accordingly be located on shield device 3 at a corresponding position relative to its lug holes in flange face 11. Alternatively, the valve stem well may be broadened into a scalloped-shaped recess, with a similar depth constraint, in order to allow the shield device 3 to better accommodate variations in wheel stem placement on different wheels while still preventing brake-to-valve stem contact. Such recesses also serve to strengthen the shield device in the area of valve stem contact, due to the introduction of stiffening bends at the ends of the recesses.

In addition to providing notches or other recesses on the shield device, in order to facilitate brake inspections and the like, holes may be provided in the conical surface of the shield device, preferably at locations where a valve stem is not to reside, and generally aligned with the components of the air disc brake. Such apertures may further be advantageous in allowing brake maintenance to be performed with the shield device remaining in place. For example, if the shield device does not extend far enough inboard so as to block the removal of brake pads from the brake caliper, a technician could insert a tool through an aperture in the shield device to, for example, drive out a brake pad retaining pin, and then extract and replace worn brake pads.

Such maintenance operations may be further facilitated by cut-out portions at the shield device's inboard edge, in areas located away from the valve stem recesses. For example, a cut-out may be provided which is wide enough to permit extraction of brake pads from the brake caliper, but leave the shield device with sufficient radial wall height that a valve stem not aligned with a valve stem recess will be deflected enough to cause a technician to feel significant resistance when installing the wheel.

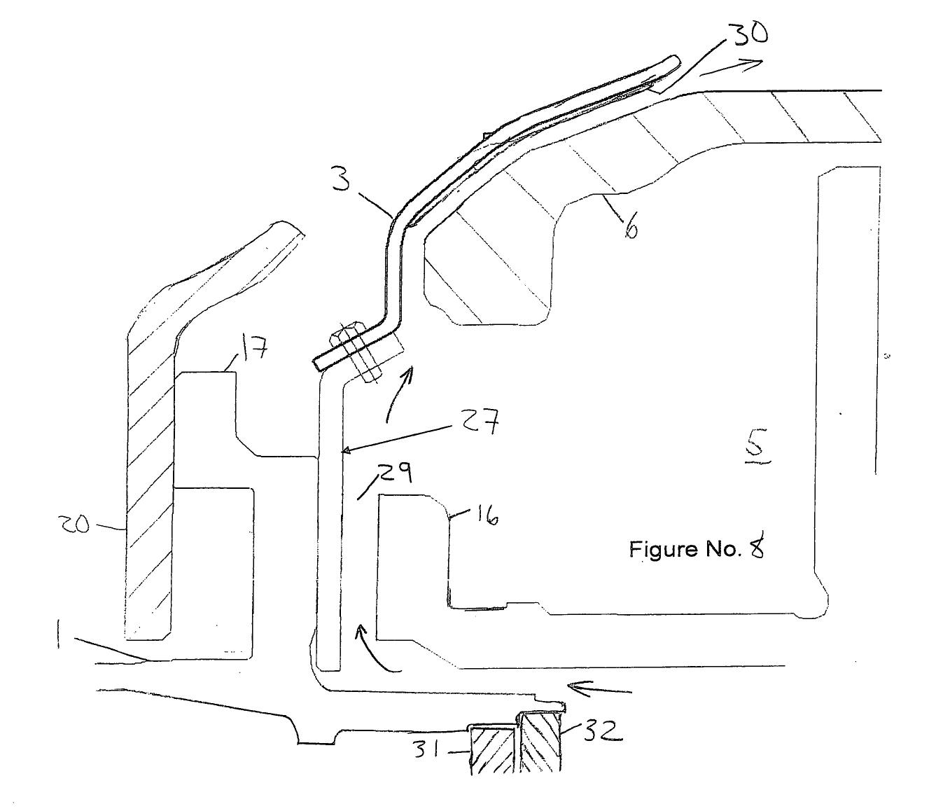

An embodiment of the present invention may also provide enhance cooling of the axle hub, wheel and brake components. As shown in FIG. 4, the brake rotor 5 may be provided with passages 29 which align with corresponding portions of the axle hub and/or the shield device to form cooling air passages. An example embodiment is illustrated in FIG. 8. FIG. 8 generally corresponds to the embodiment shown in FIG. 6, with the cross-section taken at a location about the circumference of axle hub flange face 17 which is not occupied by a lug stud 4. In this embodiment, shield device 3 is provided with vanes 30, for example, press-formed ridges or waves, on the inboard face of the shield. As the wheel, shield device, axle hub and brake rotor rotate together, the vanes 30 cause the air in the gap between the shield device to accelerate radially outwards, in the direction shown by the arrow above caliper 6 in the figure. As the air is driven outward by the vanes 30, it is replaced by air drawn through passages 29 from the region between the axle and the rotor cylindrical neck 19, as indicated by the arrows adjacent to the rotor neck. This air flow, in addition to providing cooling to the wheel, shield device and brake components, provides enhanced cooling of the axle hub's bearing 31 and seal 32. Such cooling helps extend the life of these components.

In order to facilitate the use of air disc brakes with so-called “wide base single tires” which do not fully envelope a disk brake, in a further embodiment the conical or bell-shaped portion of the shield device may be extended over the brake pad-bearing portion of the brake caliper and the outer periphery of the brake rotor. This configuration would shield the caliper and rotor from road dust and debris to which they would otherwise be exposed due to the wide base single tire's configuration.

The foregoing disclosure has been set forth merely to illustrate the invention and is not intended to be limiting. For example, while the above illustrated embodiments include a shield device with air vanes on the inboard surface of the shield, the vanes may be located at another location on the shield, on the outboard surface of the shield to enhance wheel component cooling, and/or integrated into another component, such as the axle hub flange or the rotor. Because other such modifications of the disclosed embodiments incorporating the spirit and substance of the invention may occur to persons skilled in the art, the invention should be construed to include everything within the scope of the appended claims and equivalents thereof.

What is claimed is:

1. A vehicle axle assembly with incompatible wheel protection, comprising:
an axle hub rotatably supported on an outboard end of the axle;
a disc brake, including a disc brake rotor arranged to rotate with the axle hub, and a disc brake caliper straddling the brake rotor and non-rotatably mounted on the axle; and
a disc brake shield device, wherein when a wheel is installed on the axle hub, a valve stem of the wheel is precluded by the shield device from contacting the disc brake when the wheel rotates with the axle hub.

2. The vehicle axle assembly of claim 1, wherein
the shield device includes a bell portion extending from an hub? flange face portion axially inboard and radially outward without contacting the disc brake, and
the shield device flange face includes apertures corresponding to a wheel fastener pattern of the axle hub, such that when the wheel is installed, the shield device is axially restrained between the wheel and a wheel flange face of the axle hub, and is constrained to rotate with the axle hub by fasteners securing the wheel to the axle hub.

3. The vehicle axle assembly of claim 2, wherein
the wheel fasteners include wheel lug studs arranged in a circular pattern and extending outboard from the axle hub, and
the shield device in installed on the axle by passing the device over the wheel lug studs through the apertures in the shield device flange face.

4. The vehicle axle assembly of claim 1, wherein
the shield device includes a bell portion extending axially inboard and radially outward without contacting the disc brake, and
the shield device is affixed to a hub of the disc brake rotor.

5. The vehicle axle assembly of claim 1, wherein
the shield device includes a bell portion extending axially inboard and radially outward without contacting the disc brake, and
the shield device is affixed to a mounting fixture engaged to rotate with the axle hub of the disc brake rotor.

6. The vehicle axle assembly of claim 1, wherein at least one of the shield device, the axle hub and the disc brake rotor includes air circulation surfaces arranged to cause cooling air to be circulated from a radially inward region near the shield device to a radially outward region of the shield device.

7. The vehicle axle assembly of claim 1, wherein the shield device extends radially inboard a sufficient distance to cover the brake caliper and a radially outer edge of the brake rotor.

8. The vehicle axle assembly of claim 1, wherein the shield device includes at least one wheel valve stem recess at or adjacent to an inboard edge of the shield device and configured as a depression which minimizes valve stem deflection while preventing valve stem-to-disc brake contact.

9. The vehicle axle assembly of claim 8, wherein the shield device includes at least one inboard edge cut-out portion located circumferentially away from the at least one valve stem recess and configured to permit at least one of removal and installation of components of the disc brake.

10. The vehicle axle assembly of claim 9, wherein components of the disc brake include brake pads.

11. A disc brake shield, comprising:
a disc brake shield device configured to preclude contact between a disc brake and a valve stem of a wheel when the disc brake, the disc brake shield and the wheel are installed on a vehicle axle.

12. The disc brake shield of claim 11, wherein
the shield device includes an axle flange face portion, and
the shield device flange face includes apertures corresponding to a wheel fastener pattern of an axle hub of the vehicle axle, such that when the wheel is installed, the shield device is axially restrained between the wheel and a wheel flange face of the axle hub, and is constrained to rotate with the axle hub by fasteners securing the wheel to the axle hub.

13. The disc brake shield of claim 12, wherein
the wheel fasteners include wheel lug studs arranged in a circular pattern and extending outboard from the axle hub, and
when installed on the axle, the shield device passes over the wheel lug studs through the apertures in the shield device axle flange face.

14. The disc brake shield of claim 11, wherein, when installed on the axle, the shield device is affixed to a hub of a brake rotor of the disc brake.

15. The disc brake shield of claim 11, wherein, when installed on the axle, the shield device is affixed to a mounting fixture engaged to rotate with the axle hub of the disc brake rotor.

16. The disc brake shield of claim 11, wherein the shield device includes air circulation surfaces arranged to cause cooling air to be circulated from a radially inward region of the shield device to a radially outward region.

17. The disc brake shield of claim 11, wherein the shield device extends radially inboard a sufficient distance to cover the brake caliper and a radially outer edge of the brake rotor.

18. The disc brake shield of claim 11, wherein the shield device includes at least one wheel valve stem recess at or adjacent to an inboard edge of the shield device and configured as a depression which minimizes valve stem deflection while preventing valve stem-to-disc brake contact when the shield device is installed between the disc brake and the wheel.

19. The disc brake shield of claim 18, wherein the shield device includes at least one inboard edge cut-out portion located circumferentially away from the at least one valve stem recess and configured to permit at least one of removal and installation of components of the disc brake when the shield device is installed between the disc brake and the wheel.

20. The disc brake shield of claim 19, wherein at least one cut out is sized to permit removal of disc brake pads when the shield device is installed between the disc brake and the wheel.

21. A method for precluding damage to a wheel valve stem from an air disc brake, comprising the acts of:
installing a disc brake shield device configured to preclude contact between a disc brake and a valve stem of a wheel when the disc brake, the disc brake shield and the wheel are installed on a vehicle axle.

22. The method of claim 21, wherein
the shield device includes a flange face portion, and
the shield device flange face includes apertures corresponding to a wheel fastener pattern of an axle hub of the vehicle axle, such that when the wheel is installed, the shield device is axially restrained between the wheel and a wheel flange face of the axle hub, and is constrained to rotate with the axle hub by fasteners securing the wheel to the axle hub.

23. The method of claim 22, wherein
the wheel fasteners include wheel lug studs arranged in a circular pattern and extending outboard from the axle hub, and
the act of installing the shield device includes passing the wheel lug studs through the apertures in the shield device axle flange face.

24. The method of claim 21, wherein, when installed on the axle, the shield device is affixed to a hub of a brake rotor of the disc brake.

25. The method of claim 21, wherein, when installed on the axle, the shield device is affixed to a mounting fixture engaged to rotate with the axle hub of the disc brake rotor.

26. The method of claim 21, wherein the shield device includes air circulation surfaces arranged to cause cooling air to be circulated from a radially inward region of the shield device to a radially outward region.

27. The method of claim 21, wherein the shield device extends radially inboard a sufficient distance to cover the brake caliper and a radially outer edge of the brake rotor.

28. The method of claim 21, wherein the shield device includes at least one wheel valve stem recess at or adjacent to an inboard edge of the shield device and configured as a depression which minimizes valve stem deflection while preventing valve stem-to-disc brake contact when the shield device is installed between the disc brake and the wheel.

29. The method of claim 28, wherein the shield device includes at least one inboard edge cut-out portion located circumferentially away from the at least one valve stem recess and configured to permit at least one of removal and installation of components of the disc brake when the shield device is installed between the disc brake and the wheel.

30. The method of claim 29, wherein at least one cut out is sized to permit removal of disc brake pads when the shield device is installed between the disc brake and the wheel.

31. A disc brake rotor for use with a disc brake shield device, comprising:
a rotor hub portion, the hub portion configured to be rotatably supported on a vehicle axle such that the brake rotor rotates with a wheel mounted on the axle;
a rotor friction surface portion extending radially outward from a first inboard end of the end of the rotor hub portion; and
a shield device support, extending radially outward from the rotor hub portion adjacent to a second outboard end of the hub portion,
wherein the shield device support is configured to receive and support the disk brake shield device, such that the shield device rotates with the brake rotor and shields a valve stem of the wheel from contacting the disc brake when the wheel is mounted on the axle and rotates with the axle hub.

32. The disc brake rotor of claim 31, wherein
the rotor hub portion is configured to be fixed to a rotating axle hub of the axle.

33. The disc brake rotor of claim 31, wherein
the shield device support comprises one of a radially-outward-projecting circumferential shield support flange and a plurality of radially-outward-projecting shield support platforms.

34. The disc brake rotor of claim 33, wherein
the shield device support includes shield device receiving features for non-rotating retention of the shield device.

35. The disc brake rotor of claim 34, wherein
the shield device receiving features include fastener receiving apertures.

36. The disc brake rotor of claim 35, wherein
the fastener receiving apertures receive one of threaded fasteners, rivets and retaining clips.

37. The disc brake rotor of claim 34, wherein
the shield device receiving features include at least one of interlocking slots and tabs which cooperate with corresponding shield device surfaces to provide non-rotating retention of the shield device.
